(19) United States
(12) Patent Application Publication
(10) Pub. No.: US 2007/0081928 A1
(43) Pub. Date: Apr. 12, 2007

(54) Component of an exhaust gas system

(76) Inventor: Rainer Linsler, Saarlouis (DE)

Correspondence Address: PLEVY & HOWARD & DARCY P.C., P.O. BOX 226, Fort Washington, PA, 19034, US

(21) Appl. No.: 11/545,786

(22) Filed: Oct. 10, 2006

(30) Foreign Application Priority Data
Oct. 10, 2005 (DE) DE 102005048909.5

(51) Int. Cl. B01D 53/34

(52) U.S. Cl. 422/179

(57) ABSTRACT

The invention relates to a component of an exhaust system for an internal combustion engine, having a tubular body and an insulation body which is arranged on the outside of the tubular body, forming an annular space which is arranged radially between the tubular body and the insulation body and surrounds the tubular body in the circumferential direction. The insulation body is attached to the tubular body at least on one of its axial ends with at least one welded joint on the tubular body.

### FIELD OF THE INVENTION

The present invention relates to a component of an exhaust gas system for an internal combustion engine.

### BACKGROUND OF THE INVENTION

The components considered here have exhaust gases flowing through them during operation of the internal combustion engine. In the simplest case, these are pipes carrying the exhaust. However, they are preferably more complex components of an exhaust system, e.g., particulate filters, catalytic converters or mufflers. Said components in any case have a tubular body which either serves to directly carry the exhaust gas or, in the case of the more complex components, serves as a housing to accommodate other parts of the component. It is known that the gas-carrying area of an exhaust system can become extremely hot during operation of the internal combustion engine. To reduce the thermal burden on components such as a vehicle arranged in proximity to the exhaust system, it is known that the exhaust system can be at least partially insulated. To this end, the aforementioned components of the exhaust system may be equipped with an insulation body which is arranged on the outside of the tubular body, forming an annular space arranged radially between the tubular body and the insulation body surrounding the tubular body in the circumferential direction. The tubular body and insulation body are preferably made of sheet metal, especially sheet steel and may be attached to one another, e.g., by means of at least one welded joint.

### SUMMARY OF THE INVENTION

The invention is based on the general idea of reinforcing an axial end of the insulation body by bending an edge section, whereby at the same time the folded-over edge section is incorporated into the at least one welded joint. Due to this design, this yields an increased strength for the insulation body in the area of its connection to the tubular body, so the service life of the component is increased. At the same time, this reinforcement of the insulation body can be achieved without an additional separate component and without an additional manufacturing step. The cost of implementing the inventive component is thus comparatively low.

The edge section is preferably bent approximately 180°, preferably in such a way that it is then in radial contact with an end section of the insulation body to which the edge section is connected via a bending section. The reinforcing effect of the edge section that is folded over or folded back is especially pronounced in this way.

In a refinement of the invention, the welded joint, which is preferably formed by a peripheral weld that is closed in the circumferential direction, may be arranged and adapted with dimensions so that it welds the end section to the tubular body and with the edge section, so that it seals the end section to the tubular body and the edge section. This yields an especially effective integration of the reinforced end of the insulation body into the at least one welded joint. This improves the strength of the joint between the insulation body and the tubular body and thus the durability of the component can be improved.

It is self-evident that the features mentioned above and those yet to be explained below can be used not only in the particular combination given here but also in other combinations or even alone without going beyond the scope of the present invention.

Preferred exemplary embodiments of the present invention are illustrated in the drawings and explained in greater detail in the following description, where the same reference numerals are used to refer to the same or similar functionally identical components.

### BRIEF DESCRIPTION OF THE DRAWINGS

The drawings show schematically:

FIGS. 1 through 3 each show a simplified longitudinal section through a component of an exhaust system in the area of a welded joint in various embodiments of the invention.

### DETAILED DESCRIPTION OF THE INVENTION

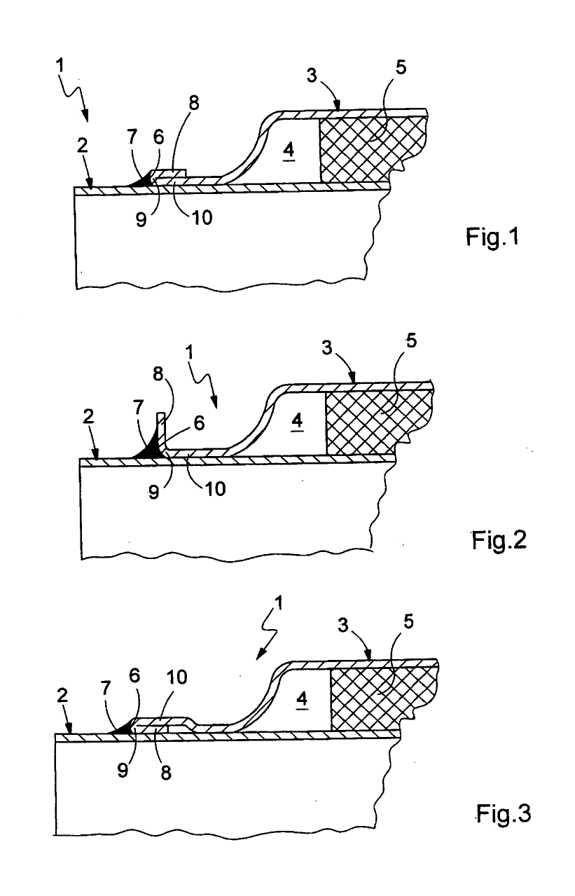

According to FIGS. 1 through 3, a component 1 of an exhaust system, not otherwise shown here, for an internal combustion engine (also not shown here) includes a tubular body 2 and an insulation body 3.

Component 1 may be, for example, an exhaust-carrying pipe of the exhaust system. In this case, the tubular body 2 forms an exhaust-carrying line section.

Likewise, component 1 may be a comparatively complex component of the exhaust system. For example, component 1 may be adapted to function as a catalytic converter or as a particulate filter or as a muffler. The tubular body 2 then forms a housing in which additional components of the respective component 1 are accommodated, e.g., a particulate filter element, a catalytic converter element or muffler components. The internal combustion engine whose exhaust is carried away with the help of the exhaust system may be installed in a motor vehicle.

The insulation body 3 surrounds the tubular body 2 in the circumferential direction, i.e., in the direction of the circumference of the tubular body 2. The insulation body 3 is arranged on the outside of the tubular body 2 so that an annular space 4 is formed radially between the tubular body 2 and the insulation body 3. Preferably an insulation material 5, e.g., in the form of an insulation mat may be accommodated in this annular space 4.

The insulation body 3 is attached to the tubular body 2. The attachment is accomplished at least at one axial end 6 of the insulation body 3 by means of at least one welded joint 7.

The following explanations refer explicitly only to the axial end 6 of the insulation body 3 illustrated in FIG. 1 through FIG. 3. It is also clear here that the insulation body 3 is designed in fundamentally the same way on its other axial end (not shown here) and may be attached to the tubular body 2.

The insulation body 3 has a folded-over edge section 8 on the axial end 6 shown here. This yields an extensive reinforcement of the insulation body 3 in the area of its axial end 6. In addition, the at least one welded joint 7 is located in the area of this edge section 8. This means that the at least one welded joint 7 is arranged in the area of the reinforcement or stiffening of the insulation body 3 achieved with the help of the folded-over edge section 8. The edge section 8 is an integral part of the insulation body 3.

The welded joint 7 is preferably a weld running in a closed form in the circumferential direction of tubular body 2.

The folded-over edge section 8 is connected to an end section 10 of the insulation body 3 via a bending section 9. The bending section 9 here forms the transition between the folded-over edge section 8 and the noncurved end section 10. The axial end 6 of the insulation body 3 is situated on this bending section 9 so that the at least one welded joint 7 attaches at least the bending section 9 to the tubular body 2.

In the embodiment of the invention illustrated in FIG. 1, the edge section 8 is folded-over radially outward, by approximately 180°. In addition, this edge section 8 in FIG. 1 is bent to the extent that it is then in contact radially with the end section 10. Through appropriate dimensioning of the at least one weld 7, this yields a type of three-layer sheet metal reinforcement in the area of the welded joint 7 between the insulation body 3 and the tubular body 2. The welded joint 7 and/or the fastening produced between the tubular 2 and the insulation body 3 is characterized by a particularly high stiffness.

In the embodiment illustrated in FIG. 2, the edge section 8 is again bent radially outward, by approximately 90°. The at least one welded joint 7 extends here into the edge area 8. Here again, a definite stiffening of the insulation body 3 in the area of the at least one welded joint 7 is achieved.

In the embodiment of the invention illustrated in FIG. 3, the edge section 8 is bent radially inward, preferably by approximately 180°. This bending is accomplished here again in such a way that the edge section 8 is in radial contact with the end section 10. Thus, there exists a three-layer sheet metal structure in the area of the at least one welded joint 7, this three-layer structure being characterized by an increased stiffness.

The at least one welded joint 7 and the sections 8, 9, 10 at the end 6 of the insulation body 3 are preferably arranged in such a way that, on the one hand, the at least one welded joint 7 welds the end section 10 directly to the tubular body 2 or welds it indirectly via the bending section 9, while, on the other hand, it welds the end section 10 directly to the edge section 8 or indirectly via the bending section 9.

1. A component of an exhaust system for an internal combustion engine comprising:
a tubular body;
an insulation body arranged on the outside of said tubular body forming an annular space enclosing said tubular body in the circumferential direction and situated radially between the tubular body and the insulation body;
wherein said insulation body is attached to said tubular body on at least one of its axial ends with at least one welded joint;
wherein said insulation body has a folded-over edge section on said one of the axial ends.

2. The component according to claim 1, wherein said folded edge section of said insulation body is attached to said end section of said insulation body via a bending section.

3. The component according to claim 2, wherein said at least one welded joint attaches said bending section to said tubular body.

4. The component according to claim 2, wherein said folded edge section of said insulation body is in contact radially with said end section of said insulation body.

5. The component according to claim 2, wherein said at least one welded joint and said sections on the end of the insulation body are arranged with one another so that said at least one welded joint welds said end section directly to said tubular body or indirectly via said bending section or welds said end section directly to said folded edge section or indirectly via said bending section.

6. The component according to claim 1, wherein said at least one welded joint is a weld running in a closed form in the circumferential direction.

7. The component according to claim 1, wherein said folded edge section is folded over radially toward the inside or radially toward the outside.

8. The component according to claim 1, wherein said radial section is folded over by approximately 180°.

9. The component according to claim 1, wherein said component is an exhaust-carrying pipe in which said tubular body serves to carry the exhaust gas.

10. The component according to claim 1, wherein said component is one of a catalytic converter, a particulate filter and a muffler, the tubular body serves as a housing of said component.

11. The component according to claim 1, further comprising an insulation material in said annular space between said tubular body and said insulation body.

12. The component according to claim 1, wherein said insulation body has such a folded over edge section on both of its axial ends.

13. The component according to claim 1, wherein said at least one welded joint is arranged at the area of said folded over edge section.

14. The component according to claim 1, wherein said at least one welded joint is a weld running in a closed form in the circumferential direction, arranged in the area of said folded over edge section.
